(19) United States
(12) Patent Application Publication
(10) Pub. No.: US 2023/0005473 A1
(43) Pub. Date: Jan. 5, 2023

(54) INFORMATION OUTPUT APPARATUS, INFORMATION OUTPUT METHOD, AND NON-TRANSITORY RECORDING MEDIUM

(71) Applicant: JVCKENWOOD Corporation, Yokohama-shi (JP)

(72) Inventors: Yoshikazu NAKAHARA, Yokohama-shi (JP); Kodal TANAKA, Yokohama-shi (JP); Yuto MATSUMOTO, Yokohama-shi (JP); Bo WANG, Yokohama-shi (JP)

(21) Appl. No.: 17/943,778

(22) Filed: Sep. 13, 2022

Related U.S. Application Data
(63) Continuation of application No. PCT/JP2021/005022, filed on Feb. 10, 2021.

(30) Foreign Application Priority Data
Mar. 24, 2020 (JP) 2020-052780

(51) Int. Cl. G10L 15/18; G10L 25/63; G06F 3/01

(52) U.S. Cl. CPC G10L 15/1815; G10L 25/63; G06F 3/016; G10L 2015/088

(57) ABSTRACT

An information output apparatus is realized that is capable of notifying information based on an input voice content. An information output apparatus according to the present embodiment includes an input unit to which data indicating a sound are input from an outside, a voice extraction unit that analyzes data which are input from the input unit and indicate a sound and that extracts data which indicate a voice emitted by a person, a vibration generation unit that generates vibration data, which are associated with data indicating a sound in advance set, based on a result of a comparison between the data which indicate the voice and are extracted by the voice extraction unit and the data indicating the sound in advance set, and a vibrator that vibrates based on the vibration data generated by the vibration generation unit.

### CROSS REFERENCE TO RELATED APPLICATION

This application is based upon and claims the benefit of priority from Japanese patent application No. 2020-52780, filed on Mar. 24, 2020, the disclosure of which is incorporated herein in its entirety by reference.

### BACKGROUND

The present disclosure relates to an information output apparatus, an information output method, and a non-transitory recording medium.

Games such as an FPS (first-person shooter) and a TPS (third-person shooter) may be played while a group is made. In this case, for example, the game is often advanced while environmental sounds in the game are heard and communication is made with another player by voice chat.

Incidentally, a portable terminal in Japanese Unexamined Patent Application Publication No. 2009-300915 is configured such that when a voice which is in advance set is input, a vibrator is actuated and notifies a user of the input.

### SUMMARY

Because in a portable terminal in Japanese Unexamined Patent Application Publication No. 2009-300915 has a problem that because a vibrator is equivalently actuated when a voice which is in advance set is input, information based on an input voice content cannot be notified.

The present disclosure has been made to solve the above problem, and an object of the present disclosure is to realize an information output apparatus, an information output method, and a non-transitory recording medium that are capable of notifying information based on an input voice content.

An information output apparatus according to an embodiment of the present invention includes:

an input unit to which data indicating a sound are input from an outside;

a voice extraction unit that analyzes data which are input from the input unit and indicate a sound and that extracts data which indicate a voice emitted by a person;

a vibration generation unit that generates vibration data, which are associated with data indicating a sound in advance set, based on a result of a comparison between the data which indicate the voice and are extracted by the voice extraction unit and the data indicating the sound in advance set; and

a vibrator that vibrates based on the vibration data generated by the vibration generation unit.

An information output method according to an embodiment of the present invention includes:

a step of analyzing data which are input from an outside and indicate a sound and of extracting data which indicate a voice emitted by a person;

a step of generating vibration data, which are associated with data indicating a sound in advance set, based on a result of a comparison between the data which indicate the voice and are extracted and the data indicating the sound in advance set; and

a step of causing a vibrator to vibrate based on the generated vibration data.

An information output program according to an embodiment of the present invention causes a computer to execute:

a process of analyzing data which are input from an outside and indicate a sound and of extracting data which indicate a voice emitted by a person;

a process of generating vibration data, which are associated with data indicating a sound in advance set, based on a result of a comparison between the data which indicate the voice and are extracted and the data indicating the sound in advance set; and

a process of causing a vibrator to vibrate based on the generated vibration data.

In the present embodiments, an information output apparatus, an information output method, and a non-transitory recording medium can be realized that are capable of notifying information based on an input voice content.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram illustrating a configuration of an information output apparatus of a first embodiment.

FIG. 2 is a flowchart illustrating a flow of an information output method by using the information output apparatus of the first embodiment.

FIG. 3 is a diagram for explaining an action in a case where a player gives an instruction to other players in a game by using the information output apparatus of the first embodiment.

FIG. 4 is a diagram for explaining an action in a case where a player tells another player a situation in a game by using an information output apparatus of a second embodiment.

FIG. 5 is a diagram for explaining an action in a case where a player tells other players a situation in a game by using an information output apparatus of a third embodiment.

### DETAILED DESCRIPTION

Hereinafter, specific embodiments to which the present invention is applied will be described in detail with reference to drawings. However, the present invention is not limited to the following embodiments. Further, the following descriptions and drawings are appropriately simplified for the purpose of clarifying the descriptions.

### First Embodiment

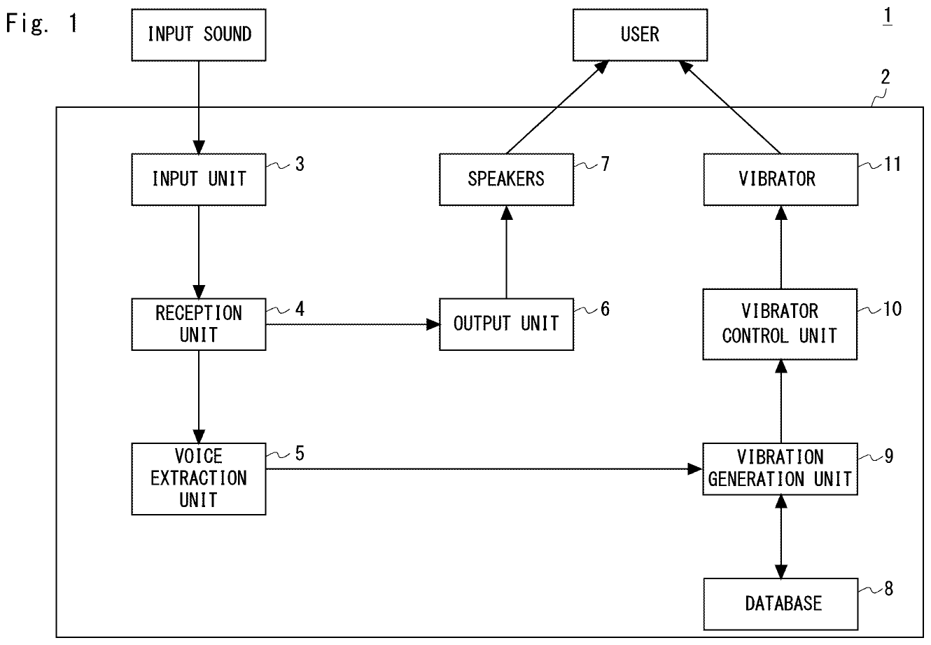

First, a description will be made about a configuration of an information output apparatus of the present embodiment. FIG. 1 is a block diagram illustrating a configuration of the information output apparatus of the present embodiment. As illustrated in FIG. 1, for example, the information output apparatus 1 includes headphones 2.

The headphones 2 are in a shape generally equivalent to common headphones and are worn on a head of a user by being put on left and right ears of the user across his/her head, for example. The headphones 2 include an input unit 3, a reception unit 4, a voice extraction unit 5, an output unit 6, speakers 7, a database 8, a vibration generation unit 9, a vibrator control unit 10, and a vibrator 11, for example.

To the input unit 3, data which indicate a sound including at least one of a voice or an environmental sound are input from a microphone, a PC (personal computer), or the like, which is not illustrated. The reception unit 4 outputs the data which are input from the input unit 3 and indicate the sound including at least one of a voice or an environmental sound to the voice extraction unit 5 and the output unit 6. The voice extraction unit 5 extracts data indicating the voice from the data which indicate the sound including at least one of a voice or an environmental sound.

The voice extraction unit 5 is caused to learn environmental sounds, for example, and can thereby remove data indicating the environmental sound from the data which indicate the sound including at least one of a voice or an environmental sound and extract data indicating the voice. However, the voice extraction unit 5 may, by using a commonly used technique, extract the data indicating the voice from the data which indicate the sound including at least one of a voice or an environmental sound. The voice extraction unit 5 outputs the data which are extracted and indicate a voice to the vibration generation unit 9.

The output unit 6 outputs the data which are input from the reception unit 4 and indicate the sound including at least one of a voice or an environmental sound to the speakers 7. The speakers 7 output the sound which is indicated by the data input from the output unit 6 and includes at least one of a voice or an environmental sound.

The database 8 stores data which indicate character strings of words included in voices in advance set, vibration data which are associated with character strings of words included in voices in advance set, data which indicate voices in nervous states in advance set (for example, data which indicate a maximum width of dispersion of pitches or levels of voices in nervous states), and vibration data which are associated with cases where voices are in nervous states, for example.

The vibration generation unit 9 converts the data, which are input from the voice extraction unit 5 and indicate the voice, into a text, thereafter executes a morphological analysis, thereby extracts a character string of a word included in the voice, compares the character string of the extracted word with character strings of words which are indicated by data read out from the database 8 and are in advance set, and reads out, from the database 8, (that is, generates) vibration data which are associated with the character string of the word in advance set in a case where a comparison result indicates equality. However, the vibration generation unit 9 is not limited to the morphological analysis but can use a common technique as long as words can be recognized from data indicating a voice.

Further, the vibration generation unit 9 compares the dispersion of the pitch or the level of the voice with the maximum width of the dispersion of the pitch or the level of the voice in the nervous state, the maximum width being read out from the database 8, based on the data which are input from the voice extraction unit 5 and indicate the voice, determines that the user is in the nervous state in a case where the dispersion of the pitch or the level of the voice is small compared to the maximum width of the dispersion of the pitch or the level of the voice in the nervous state, and reads out, from the database 8, (that is, generates) the vibration data associated with the data indicating the voice in the nervous state. However, the vibration generation unit 9 can use a common technique as long as it can be determined whether or not the nervous state is exhibited based on the data indicating the voice.

The vibration generation unit 9 outputs the read-out vibration data to the vibrator control unit 10. The vibrator control unit 10 generates control data to cause the vibrator 11 to vibrate based on the vibration data input from the vibration generation unit 9 and outputs the control data to the vibrator 11. The vibrator 11 vibrates based on the control data input from the vibrator control unit 10.

The voice extraction unit 5, the vibration generation unit 9, and the vibrator control unit 10 are formed with a microprocessor, an MPU (microprocessing unit), or a CPU (central processing unit), for example. Further, the reception unit 4 and the output unit 6 serve as interfaces which receive and output data, for example. The database 8 is formed with an HDD (hard disk drive) as a large capacity recording medium, a ROM as a semiconductor memory such as a mask ROM (read-only memory) or a PROM, and a RAM (random access memory) such as a DRAM or an SRAM, for example.

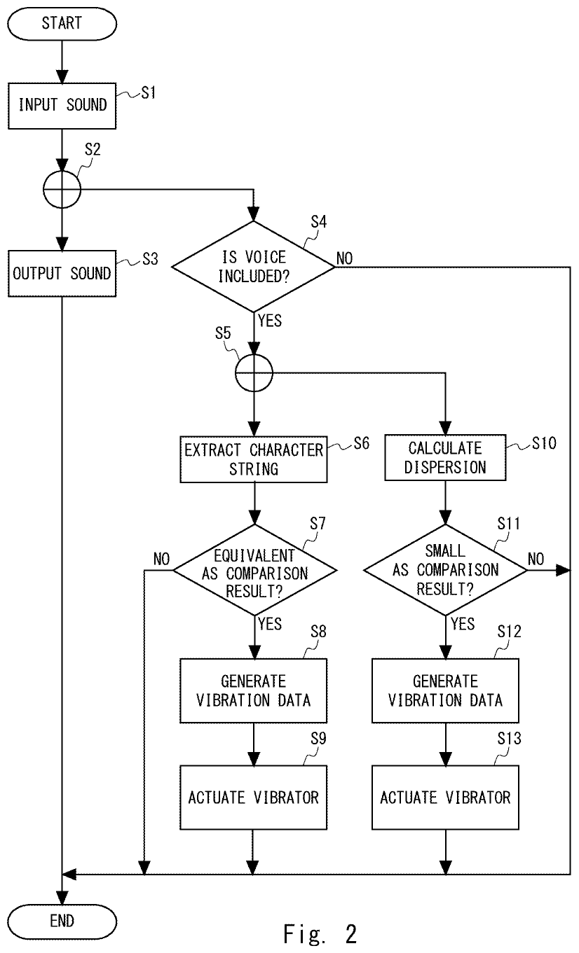

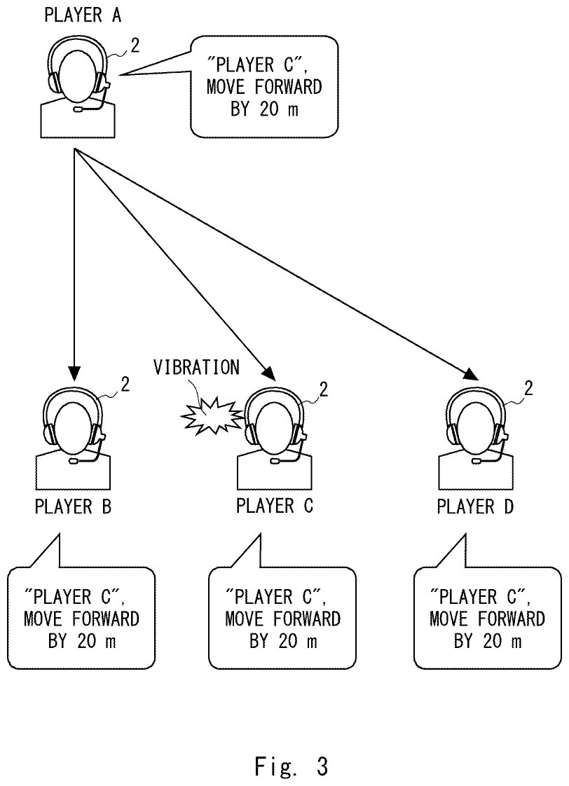

Next, a description will be made about a flow of an information output method by using the information output apparatus 1 of the present embodiment. FIG. 2 is a flowchart illustrating the flow of the information output method by using the information output apparatus of the present embodiment. FIG. 3 is a diagram for explaining an action in a case where a player (that is, the user) gives an instruction to other players in a game by using the information output apparatus of the present embodiment.

Here, in the following description, as illustrated in FIG. 3, a case is described, as an example, where players A, B, C, and D are executing a game on PCs and when each of the players is called, the vibrator 11 of the headphones 2 of the called player vibrates. In this case, it is assumed that the PCs of the players A, B, C, and D are connected together via a network and the PCs execute the information output method illustrated in FIG. 2 by the respective information output apparatuses 1.

First, when the player A says “player C, move forward by 20 m”, data which indicate a sound including a voice of “player C, move forward by 20 m” and an environmental sound around the player A are input to each of the input units 3 of the headphones 2 (S1).

Next, each of the input units 3 of the headphones 2 outputs the data which indicate the sound including the voice and the environmental sound to the reception unit 4. Then, the reception unit 4 outputs the data which indicate the sound including the voice and the environmental sound to the voice extraction unit 5 and the output unit 6 (S2).

Next, each of the output units 6 of the headphones 2 outputs the data which indicate the sound including the voice and the environmental sound to the speakers 7. Then, the speakers 7 output the sound which is indicated by the data and includes the voice and the environmental sound (S3). Accordingly, each pair of speakers 7 of the headphones 2 outputs the sound including the voice of “player C, move forward by 20 m” and the environmental sound around the player A.

At the same time, each of the voice extraction units 5 of the headphones 2 determines whether or not data indicating a voice are included in the data which indicate the sound including at least one of a voice or an environmental sound (S4). In the present embodiment, because the data include the data indicating the voice of “player C, move forward by 20 m”, the voice extraction unit 5 determines that the data indicating a voice are included in the data which indicate the sound including at least one of a voice or an environmental sound (YES in S4), extracts the data indicating a voice from the data which indicate the sound including at least one of a voice or an environmental sound, and outputs the data indicating the voice to the vibration generation unit 9. On the other hand, in a case where the data indicating a voice are not included in the data which indicate the sound including at least one of a voice or an environmental sound (NO in S4), the voice extraction unit 5 finishes a process.

Each of the vibration generation units 9 of the headphones 2 in parallel starts a generation process of vibration data based on a word included in a voice and a generation process of vibration data based on a nervous state of the voice in the following, for the data indicating the voice (S5). Specifically, the vibration generation unit 9 extracts a character string of a word included in the voice from the data indicating the voice (S6).

Next, each of the vibration generation units 9 of the headphones 2 compares the character string of the extracted word with a character string of the word which is indicated by data read out from the database 8 and is in advance set and determines whether or not a comparison result indicates equality (S7).

Specifically, the character string of each extracted word is compared with the character string of each of words which are indicated by the data read out from the database 8 and are in advance set, and it is determined whether or not the sets of character strings of the words, which agree with each other, are present.

Here, it is assumed that each of the databases 8 of the headphones 2 stores data which indicate the character string of a designation for specifying a player himself/herself who wears the headphones 2 and vibration data which indicate that the vibrator 11 provided in the headphones 2 is caused to vibrate in a case where the character string of the extracted word is equivalent to the character string of the designation for specifying the player himself/herself who wears the headphones 2.

In other words, the database 8 of the headphones 2 worn by the player A stores the data which indicate the character string of the designation for specifying the player A and the vibration data which indicate that the vibrator 11 provided in the headphones 2 worn by the player A is caused to vibrate in a case where the character string of the extracted word is equivalent to the character string of the designation for specifying the player A. Similarly, the databases 8 of the headphones 2 of the player B, the player C, and the player D store similar data.

In the present embodiment, because the voice does not include the character string of the designation for specifying each of the players A, B, and D, each of the vibration generation units 9 of the headphones 2 of the players A, B, and D determines that the comparison result indicates disagreement (NO in S7), does not read out the vibration data from the database 8, and finishes the generation process of the vibration data based on the word included in the voice.

On the other hand, because the voice includes the character string of the designation for specifying “player C”, the vibration generation unit 9 of the headphones 2 of the player C determines that the comparison result indicates equality (YES in S7), reads out the vibration data from the database 8, and outputs the vibration data to the vibrator control unit 10 (S8).

Next, the vibrator control unit 10 of the headphones 2 of the player C generates the control data based on the vibration data and outputs the control data to the vibrator 11. The vibrator 11 vibrates based on the control data input from the vibrator control unit 10 (S9).

At the same time, each of the vibration generation units 9 of the headphones 2 calculates the dispersion of the pitch or the level of the voice based on the data indicating the voice (S10). Then, the vibration generation unit 9 compares the dispersion of the pitch or the level of the voice with the maximum width of the dispersion of the pitch or the level of the voice in the nervous state, the maximum width being read out from the database 8, and determines whether or not the dispersion of the pitch or the level of the voice is small compared to the maximum width of the dispersion of the pitch or the level of the voice in the nervous state (S11).

For example, in a case where the dispersion of the pitch or the level of the voice of “player C, move forward by 20 m” is equivalent to or more than a maximum value of the dispersion of the pitch or the level of the voice in the nervous state (NO in S11), each of the vibration generation units 9 of the headphones 2 determines that the voice is not in the nervous state, does not read out the vibration data from the database 8, and finishes the generation process of the vibration data based on the nervous state of the voice.

On the other hand, in a case where the dispersion of the pitch or the level of the voice of “player C, move forward by 20 m” is small compared to the maximum value of the dispersion of the pitch or the level of the voice in the nervous state (YES in S11), each of the vibration generation units 9 of the headphones 2 determines that the voice is in the nervous state, reads out, from the database 8, the vibration data associated with a case where the voice is in the nervous state, and outputs the vibration data to the vibrator control unit 10 (S12). Here, for example, in a case where the voice is in the nervous state, the vibration data associated with the case where the voice is in the nervous state are instruction data which cause the vibrator 11 to vibrate.

Next, each of the vibrator control units 10 of the headphones 2 generates the control data which cause the vibrator 11 to vibrate based on the vibration data and outputs the control data to the vibrator 11. The vibrator 11 vibrates based on the control data input from the vibrator control unit 10 (S13).

Such information output apparatus 1 and information output method generate vibration data, which are associated with data indicating a sound in advance set, based on a result of a comparison between data indicating a voice and the data indicating the sound in advance set. Thus, information based on a voice content to be input is capable of being notified.

In other words, in the above-described example, the fact that an instruction is for the player C can be notified to the player C by vibration. Thus, the player C can easily recognize that the instruction is for the player C himself/herself and can carefully listen to the instruction by the player A without failing to hear that. Meanwhile, the other players B and D can recognize that the instruction is for the player C and concentrate on the game.

Note that the designation specifying the player himself/herself who wears the headphones 2 may be a name, a nickname, or the like as long as the name, nickname, or the like can specify the player himself/herself who wears the headphones 2.

### Second Embodiment

In an information output apparatus and an information output method of the present embodiment, when a voice for specifying a direction is input, a vibrator 11 corresponding to the direction vibrates. However, the information output apparatus and the information output method of the present embodiment are generally equivalent to the information output apparatus 1 and the information output method of the first embodiment, and the concerned descriptions will not be repeated, and descriptions will be made by using equivalent reference characters for equivalent elements.

The information output apparatus of the present embodiment includes left and right vibrators 11, for example. Furthermore, the database 8 of the information output apparatus stores data which indicate character strings of designations for specifying directions (such as left and right, for example) and vibration data in which the character strings of the designations for specifying the directions are associated with the vibrators caused to vibrate.

For example, in the vibration data in which the character strings of the designations for specifying the directions are associated with the vibrators caused to vibrate, “left” as the character string of the designation is associated with the left vibrator as the vibrator caused to vibrate, and “right” as the character string of the designation is associated with the right vibrator as the vibrator caused to vibrate.

The vibration generation unit 9 of the information output apparatus compares the character string of an extracted word with the character string of the designation for specifying the direction indicated by the data read out from the database 8. In a case where the character string of the extracted word includes the character string of the designation for specifying the direction, the vibration generation unit 9 reads out, from the database 8, the vibration data corresponding to the character string of the designation and outputs the vibration data to the vibrator control unit 10. In other words, the vibration generation unit 9 selects the vibrator 11 caused to vibrate in accordance with the designation which is included in the voice and is for specifying the direction.

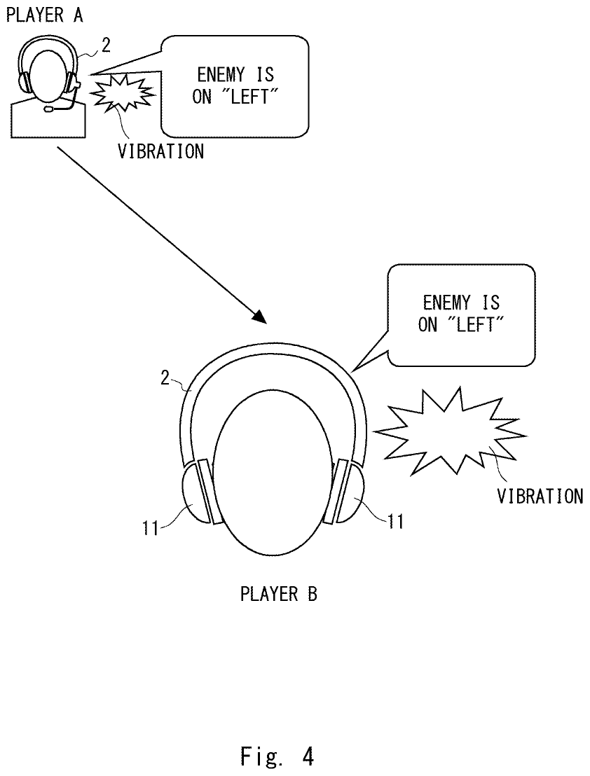

FIG. 4 is a diagram for explaining an action in a case where a player tells another player a situation in a game by using the information output apparatus of the present embodiment. Here, in FIG. 4, it is assumed that players who are executing the game are players A and B.

When the player A says “an enemy is on the left”, because the character string of the extracted words includes “left”, the vibration generation units 9 of the headphones 2 of the players A and B output the vibration data which cause the left vibrators 11 to vibrate to the vibrator control units 10.

Accordingly, the player B can instinctively recognize that the enemy is present on the left side. However, in the present embodiment, the headphones 2 are configured to include the left and right vibrators 11 but may include plural, more than two vibrators 11. In this case also, the database 8 preferably stores vibration data in which the character strings of designations for specifying directions are associated with the vibrators 11 caused to vibrate.

### Third Embodiment

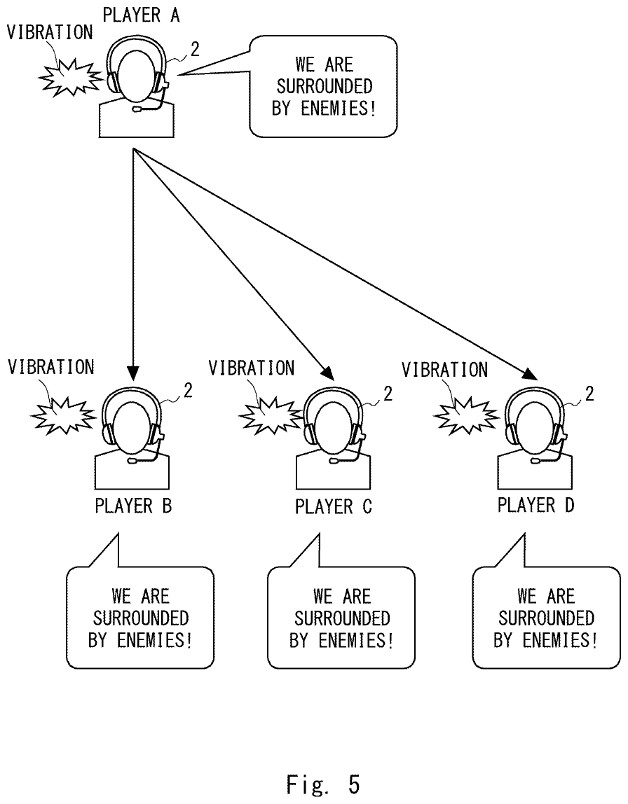

In the present embodiment, a case where a voice is in a nervous state will be described as an example. Note that a flow for processing the input voice is equivalent to the flow of the information output method of the first embodiment. FIG. 5 is a diagram for explaining an action in a case where a player tells other players a situation in a game by using the information output apparatus of the present embodiment. Here, in FIG. 5, it is assumed that players who are executing the game are players A, B, C, and D.

When the player A says “we are surrounded by enemies”, each of the vibration generation units 9 of the headphones of the players B, C, and D determines whether or not the dispersion of the pitch or the level of a voice of “we are surrounded by enemies” is small compared to the maximum value of the dispersion of the pitch or the level of the voice in the nervous state (S11 in FIG. 2).

For example, in a case where “we are surrounded by enemies” is said in the nervous state, the dispersion of the pitch or the level of the voice of “we are surrounded by enemies” becomes small compared to the maximum value of the dispersion of the pitch or the level of the voice in the nervous state, each of the vibration generation units 9 of the headphones 2 determines that the voice is in the nervous state, reads out the vibration data from the database 8, and outputs the vibration data to the vibrator control unit 10 (S12 in FIG. 2).

Accordingly, the players B, C, and D can carefully listen to nervous saying by the player A without failing to hear that.

The present invention is not limited to the above embodiments but may appropriately be modified without departing from the scope of the gist.

For example, in the information output apparatus in the above embodiments, the headphones include the voice extraction unit 5, the database 8, and the vibration generation unit 9; however, a server separate from the headphones may include the voice extraction unit 5, the database 8, and the vibration generation unit 9. In this case, pairs of headphones can share the voice extraction unit 5, the database 8, and the vibration generation unit 9. In this case, when the databases 8 stores data in which each of the pairs of headphones is associated with a designation for specifying the user who wears the pair of headphones, in a case where a voice including the designation for specifying the user who wears the pair of headphones is input, the vibrator provided in the pair of headphones worn by the user can be caused to vibrate.

For example, the information output apparatus 1 includes the headphones 2 but is not limited to this and may be a device which includes the input unit 3, the reception unit 4, the voice extraction unit 5, the output unit 6, the speaker 7, the database 8, the vibration generation unit 9, the vibrator control unit 10, and the vibrator 11, which are illustrated in FIG. 1. Further, a device does not have to include all of those configurations.

For example, a sound which is in advance set may be a sound of footsteps of an approaching enemy or the like and can appropriately be set in accordance with contents of games and so forth. Further, the vibration data may be generated such that vibration patterns are changed in accordance with character strings of extracted words or nervous states.

For example, in the above embodiments, the generation process of the vibration data based on the word included in a voice and the generation process of the vibration data based on the nervous state of the voice are in parallel executed; however, only either one may be executed, or the generation process of the vibration data based on the word included in a voice and the generation process of the vibration data based on the nervous state of the voice may be executed at different timings from each other.

For example, in the above embodiments, the present invention is described as configurations of hardware, but the present invention is not limited to such configurations. It is possible to realize the present invention by causing an arbitrary process to be executed by causing a CPU (central processing unit) to execute a computer program.

A program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first, second and third embodiments can be combined as desirable by one of ordinary skill in the art.

What is claimed is:

1. An information output apparatus comprising:
an input unit to which data indicating a sound are input from an outside;
a voice extraction unit that analyzes data which are input from the input unit and indicate a sound and that extracts data which indicate a voice emitted by a person;
a vibration generation unit that generates vibration data, which are associated with data indicating a sound in advance set, based on a result of a comparison between the data which indicate the voice and are extracted by the voice extraction unit and the data indicating the sound in advance set; and
plural vibrators that vibrate based on the vibration data generated by the vibration generation unit.

2. The information output apparatus according to claim 1,
wherein in a case where the data which indicate a voice and are extracted by the voice extraction unit include data which indicate a designation for specifying a user, the vibration generation unit generates the vibration data such that the vibrator provided in the information output device worn by the user vibrates.

3. The information output apparatus according to claim 1,
wherein in a case where the data which indicate a voice and are extracted by the voice extraction unit include data which indicate a designation for specifying a direction, the vibration generation unit generates the vibration data which select the vibrator caused to vibrate from the plural vibrators based on the data which indicate the designation for specifying the direction.

4. The information output apparatus according to claim 2,
wherein in a case where the data which indicate a voice and are extracted by the voice extraction unit include data which indicate a designation for specifying a direction, the vibration generation unit generates the vibration data which select the vibrator caused to vibrate from the plural vibrators based on the data which indicate the designation for specifying the direction.

5. The information output apparatus according to claim 1,
wherein the vibration generation unit compares the data which indicate a voice and are extracted by the voice extraction unit with data which indicate a voice in a nervous state and are in advance set and generates the vibration data, which are associated with the data indicating the voice in the nervous state, in a case where the voice extracted by the voice extraction unit is in the nervous state.

6. The information output apparatus according to claim 2,
wherein the vibration generation unit compares the data which indicate a voice and are extracted by the voice extraction unit with data which indicate a voice in a nervous state and are in advance set and generates the vibration data, which are associated with the data indicating the voice in the nervous state, in a case where the voice extracted by the voice extraction unit is in the nervous state.

7. An information output method comprising:
a step of analyzing data which are input from an outside and indicate a sound and of extracting data which indicate a voice emitted by a person;
a step of generating vibration data, which are associated with data indicating a sound in advance set, based on a result of a comparison between the data which indicate the voice and are extracted and the data indicating the sound in advance set; and
a step of causing plural vibrators to vibrate based on the generated vibration data.

8. A non-transitory computer-readable recording medium recording an information output program causing a computer to execute:
a process of analyzing data which are input from an outside and indicate a sound and of extracting data which indicate a voice emitted by a person;
a process of generating vibration data, which are associated with data indicating a sound in advance set, based on a result of a comparison between the data which indicate the voice and are extracted and the data indicating the sound in advance set; and
a process of causing plural vibrators to vibrate based on the generated vibration data.
